(19) United States
(12) Patent Application Publication
(10) Pub. No.: US 2026/0089394 A1
(43) Pub. Date: Mar. 26, 2026

(54) HAND MOVEMENT BASED ZOOM IN OUT OF CAMERA PREVIEW

(71) Applicant: MOTOROLA MOBILITY LLC, WILMINGTON, DE (US)

(72) Inventors: Kolli Kishor, Bangalore (IN); Rajesh Kumar, Bangalore (IN); Jilji N. Elayath, Bangalore (IN); Satheesh Thotasagara Vishakantappa, Bengaluru (IN)

(21) Appl. No.: 18/897,898

(22) Filed: Sep. 26, 2024

(51) Int. Cl. H04N 23/69; G01S 11/02; H04N 23/611; H04N 23/63

(52) U.S. Cl. CPC H04N 23/69; G01S 11/02; H04N 23/611; H04N 23/632

(57) ABSTRACT

An electronic device, method, and computer program product provide improved zoom functionality for a hand-held electronic device. The electronic device includes a front camera and a back camera and a distance measuring unit to detect an amount of lateral movement of the electronic device relative to a user. The processor activates an automated (auto) zoom feature while an active camera is selected to receive and capture a first image. The processor: determines a starting distance from the electronic device to the user; and in response to detecting lateral motion of the electronic device relative to the user, while the auto zoom feature is activated with the selected active camera, perform, with the active camera, an automated zoom of the corresponding FOV by performing at least one of: zooming when the electronic device moves towards the first image; or zooming out when the electronic device moves away from the first image.

### BACKROUND

### 1. Technical Field

The present disclosure relates generally to electronic devices having front and back cameras, and more particularly to image capture using electronic devices that have front and back cameras.

### 2. Description of the Related Art

Adjusting the zoom on a digital camera can be challenging. Typically, a user must engage the camera with both hands throughout the process, likely holding the camera in one hand while manipulating buttons or a touch screen with the other hand. The process increases in difficulty when the user has only one hand available, for example, when holding or carrying another item. Moreover, attempting to maintain the position of the camera while affecting zoom changes through manual manipulation of the camera may lead to unintentional movement resulting in distorted images or capturing objects other than the intended target.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts a functional block diagram of an electronic device having front and rear image capturing devices (cameras) used to implement improved zoom functionality while capturing images, according to one or more embodiments;

FIG. 2A depicts a top view of the electronic device of FIG. 1 with front image capturing device having front field of view (FOV) encompassing a face of a user at a distance that is used to implement improved zoom functionality while capturing images with the rear image capturing device, according to one or more embodiments;

FIG. 2B is a chart illustrating example zoom levels correlated to measured distances between lens of an image capturing device and a user's face, according to some embodiments;

FIG. 3A depicts the electronic device of FIG. 1, with front image capturing device having front field of view (FOV) encompassing a face of a user at a distance that is used to implement improved zoom functionality while capturing images with the rear image capturing device, using an alternative means of determining zoom levels, according to one or more embodiments;

FIG. 3B is a chart illustrating example zoom levels correlated to changes in a preview image in the distance between the left and right eye of a user's face as the electronic device is moved laterally relative to the user's face, according to some embodiments;

FIGS. 4A-4B depict example user interfaces during activation of automated zoom functionality of the electronic device shown in FIGS. 1-3, according to several embodiments;

FIG. 5A depicts examples of how the auto zoom feature can be applied during image capture of a selfie image of the user 118, based on lateral movement of the electronic device, according to one or more embodiments;

FIG. 5B is a chart illustrating example zoom levels correlated to changes in a preview image in the distance between the left and right eye of a user's face as the electronic device is moved laterally relative to the user's face, according to some embodiments;

FIG. 6 depicts a flowchart illustrating a method for improved zoom functionality of the electronic device(s) of FIGS. 1, 2A-2B, and 3A-3B, according to one or more embodiments;

FIG. 7 depicts a flowchart illustrating a second method for improved zoom functionality of the electronic device(s) of FIGS. 1, 2A-2B, and 3A-3B, according to one or more embodiments; and

FIG. 8 depicts a flowchart illustrating a third method for improved zoom functionality of the electronic device(s) of FIGS. 1 and 5A-5B, while taking a selfie image, according to one or more embodiments.

### DETAILED DESCRIPTION

According to one or more aspects of the present innovation, an electronic device, a method, and a computer program product enable improved zoom functionality for electronic devices having front and back digital cameras based on movement of a hand-held device towards and away from the face or torso of the user. Specifically, the disclosure enables automated zoom of an active device camera based on a distance of the electronic device from the operating user, and the detected or determined change in distance of the device from the user as the device is moved towards and away from the user from an initial/starting hand-held distance/position.

With conventional hand-held devices, such as mobile phones with integrated digital cameras, in order to capture an image, the user holds the electronic device in one or both hands while extending his arm partially towards the target being captured as an image. The captured image is presented as a preview image on the display screen, which can be also on the front of the electronic device facing the user. In order to zoom in or out on the target, the user is required to use one or both hands to manipulate the zoom feature of the device. This process can be time-consuming and complicated and potentially impossible to complete, particularly when the user does not have use of both hands. The present innovation removes this limitation for electronic devices that have both front and rear cameras as well as devices that have at least a front distance measuring sensor and rear camera. The innovation includes configuring the electronic device with an enhanced automated zoom feature/function that provides zooming in and out on a target by movement of the user's hand holding the device towards and away from the target. In particular, by implementing the features of the invention, the user is provided the benefit of being able to zoom in and out on a target by simply moving an extended hand that is holding the camera in and out a short distance.

According to one embodiment, the electronic device includes an enclosure that includes a first surface and a second surface opposed to the first surface. The electronic device includes at least one display device including a first display incorporated into the first surface. The electronic device has multiple image capturing devices (or cameras) including: (i) a first image capturing device, having a first field of view (FOV), embedded in a first surface of the device casing and having a first lens and that produces first image content; and (ii) a second image capturing device, having a second FOV that differs from the first FOV, embedded in a second surface of the device housing and having a second lens that produces second image content. During image capture, one of the first and the second image capturing devices is positioned as a front image capturing device that can capture an image of a FOV directed towards the user and can include the user's face, and the other one of the first and the second image capturing devices is a rear image capturing device that can capture an image of the FOV directed away from the user. The electronic device also includes at least one distance measuring unit. In operation, the distance measuring units determine the distance between the electronic device and the user, and in particular the user's face or upper torso. The electronic device can also include at least one motion sensor, such as an accelerometer and/or a gyroscope, that is/are operative to detect lateral and rotational movement/motion of the electronic device. A processor of the electronic device is coupled to the at least one display, the image capturing devices, the at least one distance measuring unit, and the at least one motion sensor(s). The processor is configured to cause the electronic device to: activate an automated (auto) zoom feature of the electronic device while one of the first and second image capturing devices is selected to receive and capture a first image within a corresponding field of view (FOV) of the selected image capturing device; and determine an approximate location of a face of a user. The processor is further configured to cause the electronic device to: in response to detecting lateral motion of the electronic device relative to the user while the auto zoom feature is activated with the selected image capturing device, perform, with the selected image capturing device, an automated zoom of the FOV that includes at least one of: (i) zoom out with a corresponding lens of the selected image capturing device upon detecting that the electronic device has been moved towards the first image; or (ii) zoom in with the corresponding lens upon detecting that the electronic device has been moved away from the first image.

According to one or more alternate embodiments, the at least one processor is configured to cause the electronic device to, while one of the first and the second image capturing devices is operating as an active camera in an image capturing mode to capture a first image within a corresponding FOV of the active camera, and the electronic device is positioned such that a next one of the first and the second image capturing devices is facing the user: (i) activate an automated (auto) zoom feature of the electronic device, (ii) determine a first distance between the user and the next one of the first image capturing device and the second image capturing device that is facing the user; and (iii) in response to lateral motion of the electronic device relative to the user, perform, with the active image capturing device capturing the image, an automated zoom function comprising at least one of: zoom in with a corresponding lens of the active camera upon detecting that the electronic device has been moved away from the user, or zoom out with the corresponding lens of the active camera upon detecting that the electronic device has been moved towards the user.

Additionally, according to one aspect of the disclosure, a method for an electronic device implementing improved zoom functionality in capturing images is disclosed. The method includes detecting, by a processor, lateral motion of an electronic device relative to a user. The method includes, in response to detecting lateral motion of the electronic device relative to a user while a first image capturing device is activated to receive a first image within a first field of view (FOV) of the first image capturing device, performing at least one of: (i) zooming out with a corresponding first lens of the first image capturing device upon detecting that the electronic device has been moved towards the first image, or (ii) zooming in with the corresponding first lens upon detecting that the electronic device has been moved away from the first image.

Also disclosed is a computer program product comprising a non-transitory computer readable medium operative to implement improved zoom functionality in capturing images. The computer program product has program instructions that when executed by a processor of an electronic device that comprises a processor communicatively coupled to a first image capturing device, a second image capturing device, and at least one distance measuring unit, configure the electronic device to perform the above presented and other method functions.

In the following detailed description of exemplary embodiments of the disclosure, specific exemplary embodiments in which the various aspects of the disclosure may be practiced are described in sufficient detail to enable those skilled in the art to practice the innovation, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, elements, names and reference numerals similar to those of the previous figure(s) may be provided. The specific numerals assigned to the elements are provided solely to aid in the description and are not meant to imply any limitations (structural, functional, or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, and several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

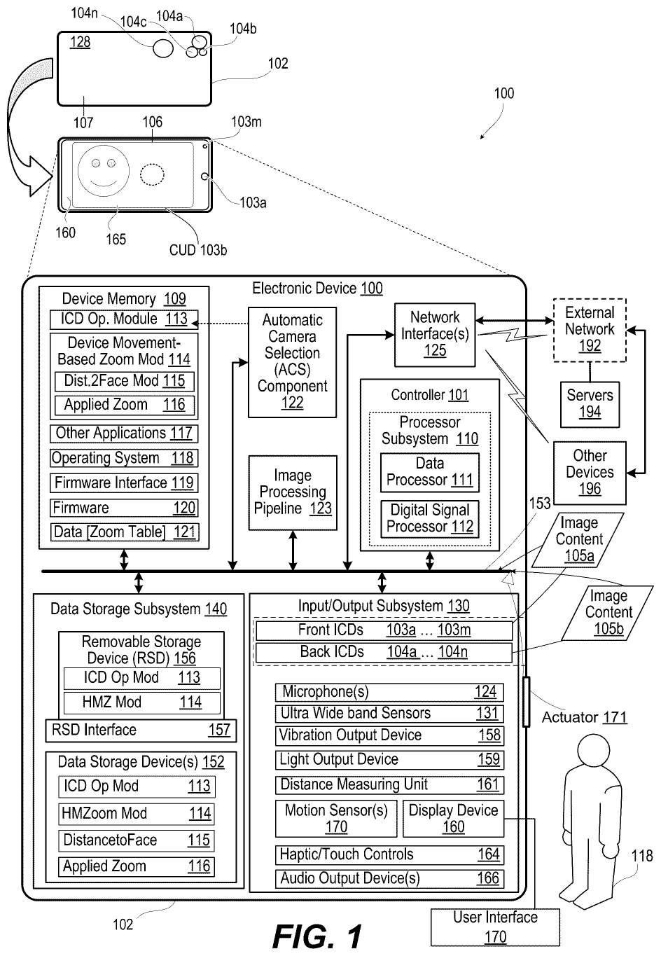

Referring now to the specific component makeup and the associated functionality of the presented components. FIG. 1 is a functional block diagram of electronic device 100 in an operating environment within which the features of the present disclosure are advantageously implemented. In particular, controller 101 of electronic device 100 is communicatively coupled to two or more image capturing devices, including at least one front image capturing device (or camera), generally represented as 103 and at least one rear/back image capturing device, generally represented as 104. In the presented example, multiple front and rear image capturing devices are presented, such as first through m^{th} front image capturing devices 103a-103m and first through n^{th} back/rear image capturing devices (second image capturing devices) 104a-104n. Controller 101 receives image content 105, such as images and video streams, from an active or selected one of image capturing devices 103, 104. Each one of image content 105 differs from the others due to respective ones of image capturing devices 103, 104 having different orientations, magnifications, fields of view, and other camera settings, etc. As an example, in the illustrated embodiments, front image capturing device 103a is an optical camera, front image capturing device 103b is a camera under the display (cud), and front image capturing device 103m is an infrared or low light camera. As an additional example, back image capturing device 104a is a telephoto camera, back image capturing device 104b is a wide-angle camera or panoramic camera, back image capturing device 104c is a macro camera, and back image capturing device 104n is a high-speed camera.

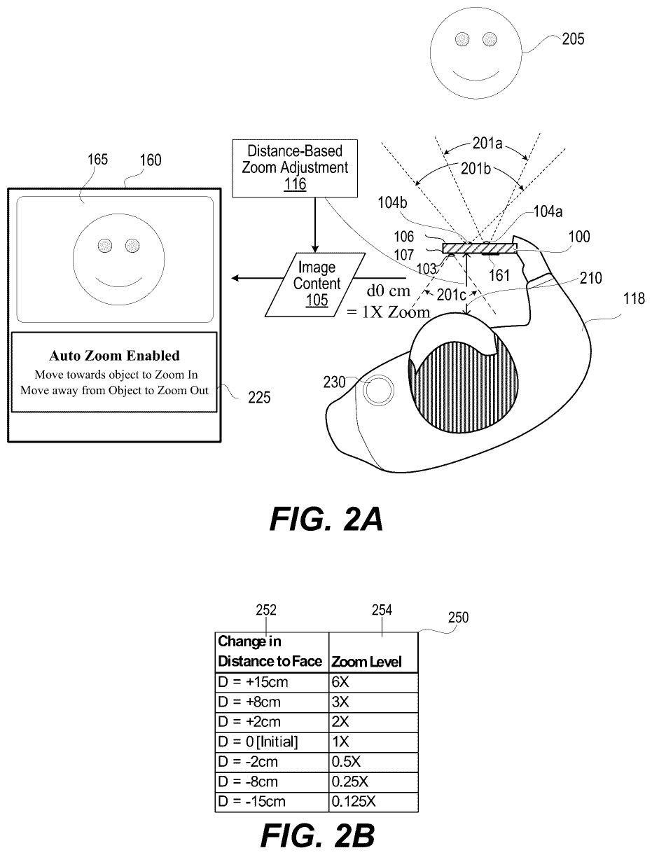

In one or more embodiments, electronic device 100 includes device memory 109, data storage subsystem 140, input/output (I/O) subsystem 130, and network interface 125, each of which is managed by controller 101. Device memory 109 includes program code for applications, such as ICD Operating module 113, Device Movement-Based (DMZ) Zoom module 114, which is shown to include Distance-to-Face Determination Module 115 and Zoom Application Determining Module 116. The DMZ module 114 manages the adjustment of the lens of the active camera in response to lateral movement of the device 100. The Distance-to-Face Determination module 115 feeds the Device Movement-Based Zoom module 114 information (distance data) on the sensed or determined distance between the device 100 and the user 118. Zoom Application Determining module 116 is operative to facilitate distanced-based zoom adjustments to the camera lens being used to provide a rendered preview image. The DMZ module 114, when executed by the processor 101, considers information from the Distance-to-face determination module 115 and utilizes the Zoom Application Determining module 116 to map and assign zoom levels and preset zoom schemes (e.g., from pre-set zoom tables, FIG. 2A) in determining an appropriate zoom level to apply, in light of the detected/determined change in distance of the device 100 relative to the user 118. For the sake of simplicity, functions carried out by said elements may be described as being performed by the controller/processor 101. Additionally, while presented as different modules and sub-modules, it is appreciated that all of the features and functionality of the above-described modules can be integrated into a single application of an artificial intelligence (AI) engine configured to provide the automated distance-based zoom features described herein.

Device memory 109 further includes other application(s) 117, operating system (OS) 118, firmware interface 119, such as basic input/output system (BIOS) or Uniform Extensible Firmware Interface (UEFI), and firmware 120. In some embodiments, device memory 109 can also include Automatic Camera Selection (ACS) component 122. Alternatively, ACS component 122 may be a dedicated digital signal processing module or feature of image processing pipeline 123. Image processing pipeline 123 performs additional image processing algorithms or adjustments to images captured by one or more of image capturing devices 103, 104. In some embodiments, during implementation of the zoom features described herein, ACS component 122 can select between two or more available cameras facing the target object as the active camera. As an example, ACS component 122 can select telephoto back camera 104a to zoom in on that target object when the electronic device 100 is moved towards the target object, or alternatively, ACS component 122 can select wide-angle back camera 104b to zoom out on the target object (or the general FOV) when the electronic device 100 is moved away from the target object. As described herein, the amount of zoom applied is directly correlated to the measured or determined distance and changes from an original/starting distance between the electronic device 100 and the operating user 118. Device memory 109 stores preview image data 121 that may be used by ACS component 122, ICD Operating module 113, Distance-to-Face Determination module 115, Zoom Application Determining module 116, and other application(s) 117.

Controller 101 can interchangeably be referred to as processor 101. Controller 101 includes processor subsystem 110, which executes program code to provide operating functionality of electronic device 100. The software and/or firmware modules have varying functionality when their corresponding program code is executed by processor subsystem 110 or secondary processing devices within electronic device 100. Processor subsystem 110 of controller 101 can execute program code of ACS component 122, ICD Operating module 113, Device Movement-Based Zoom module 114, and each of the other modules and other application(s) 117 within memory 109 to configure electronic device 100 to perform specific functions, including the functions described herein. Device memory 109 can include data 121, such as zoom table (FIG. 2B), that is used by ACS component 122, ICD Operating module 113, DMZ module 114, Distance-to-Face Determination module 115, Zoom Application Determining module 116, and other application(s) 117.

Data storage subsystem 140 of electronic device 100 includes data storage device(s) 152. Controller 101 is communicatively connected, via system interlink 153, to data storage device(s) 152. Data storage subsystem 140 provides applications, program code, and stored data on nonvolatile storage that is accessible by controller 101. For example, data storage subsystem 140 can provide a selection of applications and computer data, such as ACS component 122 and other application(s) 117. These applications can be loaded into device memory 109 for execution by controller 101. In one or more embodiments, data storage device(s) 152 can include hard disk drives (HDDs), optical disk drives, and/or solid-state drives (SSDs), etc. Data storage subsystem 140 of electronic device 100 can include removable storage device(s) (RSD(s)) 156, received in RSD interface 157. Controller 101 is communicatively connected to RSD 156, via system interlink 153 and RSD interface 157. In one or more embodiments, RSD 156 is a non-transitory computer program product or computer readable storage device. Controller 101 can access RSD 156 or data storage device(s) 152 to provision electronic device 100 with program code, such as code for the DMZ module 114 and sub-modules (115-116) presented within memory 109, ACS component 122 and other application(s) 117.

I/O subsystem 130 includes image capturing devices such as front image capturing devices 103a-103m and back image capturing devices 104a-104n. I/O subsystem 130 also includes vibration output device 158, light output device 159, display device 160, distance measuring unit 161, microphone 124, touch/haptic controls 164, audio output device(s) 166, and motion sensor(s) 170 including an accelerometer, a gyroscope and other motion sensors. Display device 160 is communicatively coupled to controller 101 and includes a screen on which is presented preview image 165 of an image captured by one of front or rear image capturing devices 103 or 104. Front image capturing devices 103a-103m are on a front side 106 of electronic device 100 along with display device 160. Back image capturing devices 104a-104n are at back/rear side 107 of electronic device 100.

Controller 101 manages, and in some instances directly controls, the various functions and/or operations of electronic device 100. These functions and/or operations include, but are not limited to including, application data processing, communication with second communication devices, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic.

Controller 101 includes processor subsystem 110, which includes one or more central processing units (CPUs), depicted as data processor 111. Processor subsystem 110 can include one or more digital signal processors 112 that are integrated with data processor 111. Processor subsystem 110 can include other processors that are communicatively coupled internally or externally to data processor 111. Data processor 111 is communicatively coupled, via system interlink 153, to device memory 109, data storage subsystem 140, and network interface 125. Network interface 125 enables electronic device 100 to connect (via wireless or wired connection) to external network 192 and directly/indirectly to other devices 196. Network 192 provides connection to and can include one or more network servers 194 and can provide connection to other devices 196. Electronic device 100 is thus able to connect with servers 194 and other devices 196 to share and/or download application data that can be utilized to implement features of the disclosure. System interlink 153 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (system interlink 153) are illustrated in FIG. 1, it is to be understood that more, fewer, or different interconnections may be present in other embodiments.

FIG. 2A depicts a top view of the electronic device 100 being held by user 118 and used to capture image content 105 (of an object 205) received from one or more rear image capturing devices 104 (e.g., telephoto ICD 104a and wide-angled ICD 104b) from a corresponding FOV 201a or 201b, according to some embodiments. FIG. 2B presents a zoom table 250 with example mapping of zoom levels 254 to respective distances 252 between the device 100 and the face of the user 118, according to one embodiment. With ongoing reference to FIG. 1 while referring to the additional features presented by FIGS. 2A-2B, electronic device 100 is configured to implement improved zoom functionality in capturing images based on a distance of the electronic device from the operating user. Electronic device 100 includes an enclosure 102 (i.e., an exterior casing) that includes a first surface 106 and a second surface 107 opposed to the first surface 106. The electronic device includes at least one display device, including a first display 160 incorporated into the first surface 106. The electronic device has multiple image capturing devices (or cameras) including: (i) a first image capturing device, having a first field of view (FOV), embedded in a first surface of the device casing and having a first lens and that produces first image content; and (ii) a second image capturing device, having a second FOV that differs from the first FOV, embedded in a second surface of the device housing and having a second lens that produces second image content. During image capture, one of the first and the second image capturing devices is positioned as a front image capturing device that can capture an image of a FOV directed towards the user and can include the user's face, and the other one of the first and the second image capturing devices is a rear image capturing device that can capture an image of the FOV directed away from the user. The electronic device also includes at least one distance measuring unit/component. In operation, the distance measuring component/unit senses, measures, or determines the distance between the electronic device and the user, and in particular the user's face or upper torso. The electronic device can also include at least one motion sensor, such as an accelerometer and/or a gyroscope, that is/are operative to detect lateral and rotational movement/motion of the electronic device.

A processor of the electronic device is coupled to the at least one display, the image capturing devices, the at least one distance measuring unit, and the at least one motion sensor(s). The processor is configured to cause the electronic device to: activate an automated (auto) zoom feature of the electronic device while one of the first and second image capturing devices is selected as an active camera to receive and capture a first image within a corresponding field of view (FOV) of the selected image capturing device; and determine a starting/original distance from the device to a face or torso of a user. The processor is further configured to cause the electronic device to: in response to detecting lateral motion of the electronic device relative to the user while the auto zoom feature is activated for the selected image capturing device, perform, with the selected image capturing device, an automated zoom of the FOV that includes at least one of: (i) zoom in with a corresponding lens of the selected image capturing device upon detecting that the electronic device has been moved towards the first image; or (ii) zoom out with the corresponding lens upon detecting that the electronic device has been moved away from the first image.

According to one or more alternate embodiments, the at least one processor is configured to cause the electronic device to, while one of the first and the second image capturing devices is operating as an active camera in an image capturing mode to capture a first image within a corresponding FOV of the active camera, and the electronic device is positioned such that a next one of the first and the second image capturing devices is facing the user: (i) activate an automated (auto) zoom feature of the electronic device, (ii) determine a first distance between the user and the next one of the first image capturing device and the second image capturing device that is facing the user; and (iii) in response to lateral motion of the electronic device relative to the user, perform, with the active image capturing device capturing the image, an automated zoom function comprising at least one of: zooming in with a corresponding lens of the active camera upon detecting that the electronic device has been moved away from the user; or zooming out with the corresponding lens of the active camera upon detecting that the electronic device has been moved towards the first user.

In some embodiments, the second surface, which is opposed to the first surface is directed towards the face of the user. In some embodiments, the at least one processor is further configured to map a calculated or measured distance to a corresponding zoom level, and, with the auto zoom feature activated, continually calculate a distance between the electronic device and the face or torso of the user. In some embodiments, the distance between the electronic device and the user (e.g., the approximate location of the face or torso of the user) is measured using ultra-wide band (UWB) sensors, where the user is wearing or has a UWB tag 230 on his person.

Referring specifically to FIG. 2A, in one or more embodiments, rear image capturing device 104a is designated as the camera in service (i.e., the active camera or the selected camera receiving and capturing the image of a corresponding FOV). When the device is placed in auto zoom mode, active rear image capturing device 104a operates in preview mode and captures a preview of image content 105 within the corresponding FOV (201a). The image content 105 is presented as preview image 165 on display 160 for viewing by user 118. The display 160 renders a preview image 165 of image content 105, along with instructions 225 for altering a zoom level of preview image 165. Distance measuring/monitoring unit 161 measures or calculates the distance 210 between the device 100 and the face of user 118. The processor causes the device to perform a distanced-based zoom adjustment to image content 105 via the zoom application determining module 116 (FIG. 1), factoring in the changes in measured or determined distance 210, by mapping the initial/starting distance 210 and subsequent changes in distance 210 to a corresponding initial baseline image (no zoom) and subsequent zoom levels, as detailed in FIG. 2B. In response to the user moving the device 100 towards the target object 205, the processor receives the updated distance (or change in distance) from the distance measuring/monitoring unit 161, determines the change in distance between the device 100 and the user's face, and calculates (or retrieves from pre-determined zoom table 250) a corresponding zoom level, based on the change in distance 210. Alternatively, the distance between the user 118 and the device 100 may be measured using ultra wide band (UWB) technology. Specifically, UWB sensor 131 within the device 100 can pinpoint and/or track the location of wearable UWB tag 230 attached to the user 118. The processor communicates the zoom level to the zoom application determining module 116 and/or directly triggers the lens of the active/selected camera to zoom according to the calculated or determined zoom level, as presented in FIG. 2B, while the device 100 is being moved towards the target object 205 and to zoom out, while the device 100 is being moved away from the target object 205. The corresponding zoom levels are applied to active rear image capturing device 104a to alter the zoom level of the corresponding lens, which results in corresponding changes to preview image 165. The user 118 may trigger the active ICD to capture the image when the desired zoom level is reached.

FIG. 2B is a table 250 depicting an exemplary mapping of different zoom levels to respective changes in the distance, D 210, between the device 100 and the face of the user 118. When the auto zoom feature of the device 100 is initially activated and the device 100 is held stationary (i.e., no lateral movement of the device for a minimum threshold time, e.g., 2 seconds), the initial distance, d0 is measured/determined and correlated to zoom level 1× or normal magnification, which is represented within table 250 as change in distance (D)=0. Table 250 provides a mapping of the changes in the measured/determined distance, D, from the initial separation distance d0, with positive values indicating movement of the device 100 away from the user's face and negative values indicating movement of the device 100 towards the user's face. The exemplary range shown in the chart spans from a distance 15 cm closer (i.e., −15 cm) to the face of the user 118 than D=0 to 15 cm further away (+15 cm) from the face of the user 118 than D=0. With change in distance D=−15 cm, the zoom level is 0.125 times normal magnification. With change in distance D=+15 cm, the zoom level is 6 times normal magnification. Other magnification schemes may be utilized. Magnification schemes may be preset or changed, for example, according to the preferences of the user 118.

In some embodiments, the electronic device further comprises a third image capturing device embedded on a same surface as the active camera and having a second FOV of the image different from that of the corresponding first lens of the active camera, and the processor is further configured to autonomously select an active image capturing device to capture an image preview from among the active image capturing device and the third image capturing device based on an amount of zooming in and zooming out required as the electronic device is moved towards and away from the face or torso of the user.

In some embodiments, the at least one processor is further configured to preview on a display of the electronic device a potential image scaled as per a current zoom level. The at least one processor is further configured to lock a zoom level in response to detecting a user input (e.g. a non-linear movement of the electronic device) or in response to no change in the lateral distance of the electronic device for a preset threshold period (e.g., 4 seconds). The at least one processor is further configured to capture the potential image upon receipt of a selection of one of a virtual image capture selector/option presented on the display or a physical button of the electronic device.

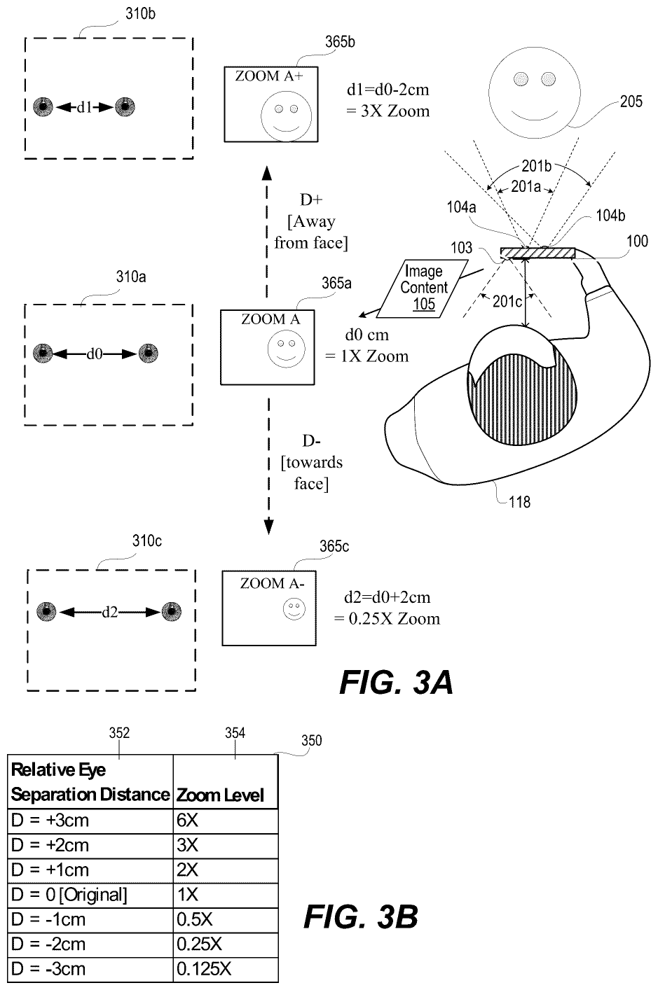

FIG. 3A depicts an alternate embodiment of how electronic device 100 performs auto zoom features to apply a zoom level to an image during image capture of an object 205 based on a distance of the electronic device to the user. With this alternate embodiment, electronic device 100 does not have (or is not required to have) a distance measuring unit. Rather, electronic device 100 relies on a series of captured preview images from the ICD that is facing the user to evaluate and determine the relative change in distance between the device and the user based on changes in relative distance between the eyes of the user within the captured preview images of the user's face. In the illustrated embodiments, one rear image capturing device 104 (e.g. 104a or 104b) with corresponding FOV 201a or 201b is selected as the active camera operating in preview mode. The display 160 renders a rear image capturing device preview image 365, from image content 105. Front image capturing device 103 (e.g. 103a) has FOV 201c that captures the face, including left and right eyes, of user 118. Following activation of the auto zoom feature, an internally produced front image capturing device preview image 310a is analyzed to determine an initial relative distance ‘d0’ (prior to measuring lateral movement by the device) between the left eye and right eye of the user (e.g., in pixels) in preview image 310a. The zoom level at d0 is assigned as normal magnification, or 1× within table 350. As shown in table 350, the zoom level 354 varies as the relative eye separation distance 352 varies within the front image capturing device preview images 310, according to a predetermined scale, for example, the scale detailed in FIG. 3B. The zoom level is applied to the active rear image capturing device 104a to alter the zoom level of the lens of the active camera, which affects the rear image capturing device preview image 365 within the display. The user 118 may capture the image when the desired zoom level is reached. Lateral movement of the electronic device 100 toward the face/eyes of the user 118 results in a decreased zoom level while lateral movement of the electronic device away from the face/eyes of the user 118 results in an increased zoom level. Zoom level A shown in rear image capturing device preview image 365a depicts a starting point (d0) before auto-zoom features are applied to the preview image (i.e., auto-Zoom=A or 0) and before lateral motion of the electronic device 100 towards or away from the user 118. Zoom level A− depicts a zoom level associated with lateral movement of the electronic device 100 closer to the eyes/face of the user 118 (further away from the object 205) than the distance depicted at zoom level A. With zoom level A−, the object 205 appears smaller within the rear image capturing device preview image 365, corresponding to zoom level A−, than within rear image capturing device preview image 365a. Zoom level A+ depicts a zoom level associated with lateral movement of the electronic device 100 further away from the eyes/face of the user 118 (closer to the object 205) than the distance depicted at zoom level A. With zoom level A+, the object 205 appears larger within rear image capturing device preview image 365b, corresponding to Zoom level A+, than within rear image capturing device preview image 365a. In auto-zoom mode, the processor 101 continually maps updated zoom levels, applying the zoom level to the corresponding lens of the active rear image capturing device 104. The processor 101 triggers a corresponding zoom in or out of the corresponding lens based on the updated zoom levels. After the appropriate zoom level is determined, user 118 can trigger rear image capturing device 104 to capture the image content 105b. In one alternate embodiment, while electronic device 100 is in auto-zoom mode, rear image capturing device 104 can be pre-programmed to automatically capture the image once the user stops moving the electronic device for greater than a threshold period of time (e.g., 3 seconds).

FIG. 3B is a chart depicting an exemplary mapping of zoom levels to respective distances between the eyes of the user 118 as captured in front image capturing device preview images 310 from the front ICD 103 facing the user. When the device 100 is stationary (no motion/lateral movement of the device towards or away from the object has yet occurred), the zoom level is 1× or normal magnification (relative eye separation distance (D)=0). The exemplary range shown in the chart spans from relative eye separation distance 3 cm closer (−3 cm) to each other than D=0 to 3 cm further away (+3 cm) from each other than D=0. At distance D=−3 cm, the zoom level is 0.125 times normal magnification. At D=+3 cm, the zoom level is 6 times normal magnification. Other magnification schemes may be utilized. Magnification schemes may be preset or changed, for example, according to the preferences of the user 118.

Accordingly, in some embodiments, the at least one processor is further configured to detect eyes of the face of the user within a pre-capture image of the face within the FOV of the first image capturing device. The at least one processor is further configured to measure an initial relative distance between the eyes of the user. The at least one processor is further configured to measure subsequent relative distances between the eyes of the user each time the electronic device stops after moving away from the user or towards the user. The at least one processor is further configured to continually map ratios of the subsequent relative distances compared with the initial relative distance value to calculate updated zoom levels. The at least one processor is further configured to trigger a corresponding zoom in or out of the second lens based on the calculated updated zoom levels. In further embodiments, the at least one processor is further configured to select a zoom level according to preset user preference after mapping is completed.

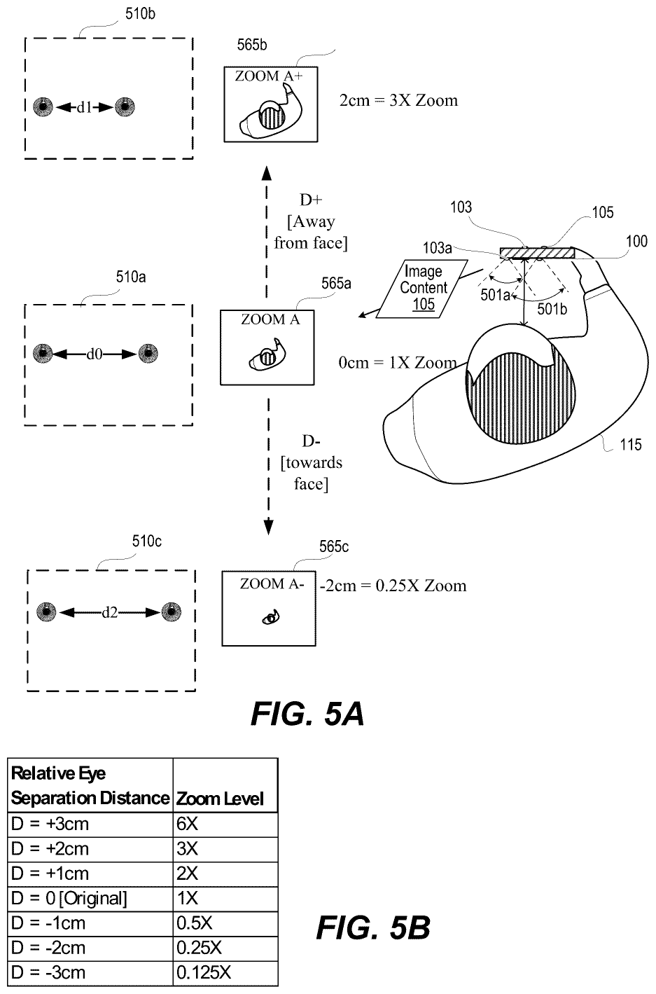

It is appreciated that the use of the relative separation distance of the eyes is only a proxy for determining the amount of lateral movement of the electronic device relative to the face of the user. When the electronic device has an integrated distance measuring unit or UWB sensor or RFID sensor option for directly determining the change in distance between the device and the user, the methodology of FIGS. 2A-2B can be utilized in place of that of FIGS. 3A-3B (and similarly FIGS. 5A-5B, described later).

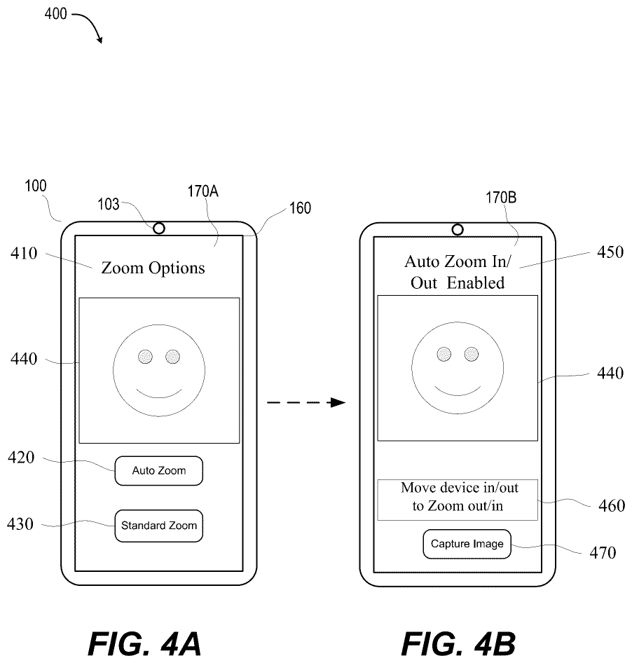

FIGS. 4A and 4B depict example user interfaces of example electronic device 100 as depicted in FIGS. 1-3. In one or more embodiments, the user interface 170A shown in FIG. 4 may be rendered on display 160 of electronic device 100 of FIG. 1. In capturing images as described in FIGS. 1-3, processor 101 is configured to cause the electronic device 100 to render content to the user interface 169 of display 160. FIG. 4 depicts content presented on display 160 following activation of rear image capturing device 104 (not shown), which captures preview image content 105a as depicted in FIG. 2A. User interface 170A presents initial zoom options 410, which include selectable options for initiating/activating auto zoom 420 and standard zoom 430. FIG. 4B presents second user interface 170B following selection of auto zoom 420 in user interface 170A. Second user interface 170B presents zoom status notification 450 indicating that auto zoom is enabled on device. Zoom status notification 450 may disappear after some time (e.g., a few seconds). User interface 170B includes zoom instructions 460 that inform the user that the zoom level associated with the preview image 440 may be altered by moving the electronic device 100 forwards or backwards. Upon reaching a desired zoom level, the user may depress the rendered capture image virtual button 470 to capture the image of the object 205 (FIG. 2) at the desired zoom level. Alternatively, in one embodiment, the user may lock in the desired zoom level by tapping anywhere on the user interface 170 (away from the selection buttons).

In one or more embodiments, device 100 may be triggered to enter auto-zoom mode in response to a quick movement of the device, such as a 45 degree tilt or rotation of device 100 by the user or viewing the same object in the viewfinder/display for 3-5 seconds. Similarly, while the device 100 is in auto-zoom mode, an image may be captured automatically under certain circumstances, for example, when an image or preview image remains in the viewfinder/display for a time exceeding a preset threshold duration without further lateral movement of the electronic device. In some embodiments, the user may be presented with other preprogram settings such that other features such as focus and flash appear prior to zoom lock and picture capture.

In some embodiments, the at least one processor is further configured to cause the electronic device to detect activation of an auto zoom feature of the electronic device, and in response to detecting the activation of the auto zoom feature, output a notification of the activation in order to alert a user of the electronic device of availability of the auto zoom feature.

FIG. 5A depicts one example of how the auto zoom feature can be applied during image capture of a selfie image of the user 118, based on lateral movement of the electronic device, according to one or more embodiments. The zoom determining features of FIG. 5A are similar to those of FIG. 3A, which relies on the relative separation distances of the eyes. However, the selfie implementation of FIG. 5A utilizes a different zoom table, a selfie zoom table 550, to assign zoom levels to the eye separation distance preview 510 and preview selfie image 565. In the illustrated embodiments, one of front image capturing device 103 (e.g. 103a or 103b) having corresponding FOV 501a or 501b is activated as an active camera operating is selfie mode, with auto-zoom feature enabled on electronic device 100. The display 160 renders a preview selfie image 565, from image content 105. The processor may autonomously select one image capturing device from the side of the device facing the user, from among two or more front image capturing devices, e.g., ICD 103a and 103m (which can be taken together as the first image capturing device) or CUD 103b (taken as the third image capturing device), with which to measure an initial relative distance ‘between the eyes of the user, in pixels. The zoom level at initial measured distance, d0, is taken to be normal magnification, or 1×. The zoom level varies as the distance between the eyes varies on the eye separation distance preview image, according to a predetermined scale, for example, the scale detailed in table 550 of FIG. 5B. The user 118 may capture the image when the desired zoom level is reached. Lateral movement of the electronic device 100 toward the face/eyes of the user 118 results in an increased zoom level while lateral movement of the electronic device away from the face/eyes of the user 118 results in a decreased zoom level. In auto-zoom mode, the processor 101 continually determines or calculates updated zoom levels, seamlessly applying the zoom level to active front image capturing device 103. The processor 101 triggers a corresponding zoom in or out of the lens of the image capturing device 103 based on the updated zoom levels. After the appropriate zoom level is determined, user 118 can trigger active front image capturing device 103 to capture the image content 105. In one alternate embodiment, while electronic device 100 is in auto-zoom mode, front image capturing device 103 can be pre-programmed to automatically capture the image once the user stops moving the electronic device 100 for greater than a threshold period of time (e.g., 3 seconds).

FIG. 5B presents a selfie auto-zoom table 550 depicting an exemplary mapping of zoom levels to respective changes in distances between eyes of the user 118 as rendered within preview selfie image 565, which correlates to corresponding zoom levels. Magnification schemes for selfie auto-zoom table 550 may have a different scale for magnification than normal auto-zoom table 350 of FIG. 3B. The magnification schemes may be preset or can be AI generated and user modified, for example, according to the preferences of the user 118.

In some embodiments, the processor is further operative to, in response to the electronic device being placed in a selfie mode: present a selfie-image of a face of the user within a display screen of the electronic device; and apply the distance-based auto zoom feature to determine a level of zoom to apply to the active camera capturing the selfie, by zooming in on the face of the user in response to detecting movement of the electronic device towards the face of the user and zooming out on the face of the user in response to detecting movement of the electronic device away from the face of the user.

In some embodiments, the device further comprises a third image capturing device embedded on a same surface as the first image capturing device and having a third lens that has a different FOV from the first lens, and wherein to zoom in and zoom out, the at least one processor autonomously selects an active image capturing device to capture an image preview from among the first image capturing device and the third image capturing device.

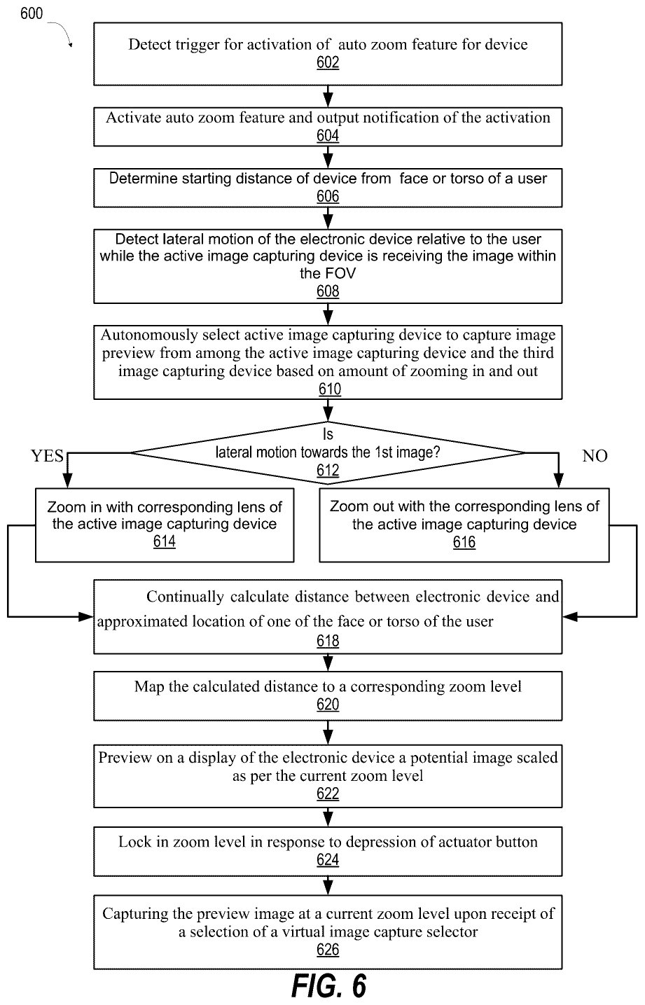

Referring now to the flowcharts presented by FIGS. 6-8, the descriptions of the methods in FIGS. 6-8 are provided with general reference to the specific components and features illustrated within the preceding FIGS. 1-5B. Specific components referenced in the methods of FIGS. 6-8 may be identical or similar to components of the same name used in describing preceding FIGS. 1-5B . In one or more embodiments, processor 101 (FIG. 1) configures electronic device 100 (FIG. 1) to provide the described functionality of the methods of FIGS. 6-8 by executing program code for one or more modules or applications provided within device memory 109 of electronic device 100, including ICD Operating module 113, DMZ module 114, and ACS component 122 (FIG. 1).

FIG. 6 depicts a flowchart illustrating a method for improved zoom functionality of an electronic device having multiple image capturing devices, according to one or more embodiments. The method starts at block 602 where the electronic device detects a trigger for activating auto zoom while the device is operating in an image capturing mode with an active camera. In response to detecting the trigger, the method 600 includes activating auto zoom feature on the device and providing a notification of the activation of the auto zoom feature (block 604). The method proceeds to block 606, where the electronic device determines the initial distance between the electronic device and the face of the user (i.e., a calculated or measured distance of the face of the user relative to the electronic device). In some embodiments, the location can be determined using a distance measurement unit which measures the distance between the electronic device and the user's face or torso. The method continues to block 608, where the electronic device determines or senses whether lateral motion of the device relative to the user has occurred. Detection of lateral movement can be performed by the DMZ module 114 (FIG. 1) and can make use of an accelerometer or other motion sensor. The method continues to block 610, where the electronic device autonomously selects an active image capturing device to capture an image preview from among the active image capturing device and a third image capturing device based on an amount of zooming in and zooming out required as the electronic device is moved towards and away from the face or torso of the user. The third image capturing device is embedded on a same surface as the active camera and has a second FOV of the image different from that of the corresponding first lens of the active camera.

The method 600 continues to block 612, where the electronic device determines whether detected lateral motion of the electronic device is towards the object or away from the object. If the lateral motion detected was towards the object, the method continues to step 614, where the electronic devices zooms in with a corresponding lens of the active image capturing device if the electronic device has been moved towards the first image (object). If the lateral motion detected was not towards the object, that is, the lateral motion detected was away from the object, the method continues to step 616, where the electronic device zooms out with the corresponding lens of the active image capturing device upon detecting that the electronic device has been moved away from the first image (object). The method continues from either step 614 or 616 to step 618, where the device continually calculates a distance between the electric device and an approximated location of one of the face or torso of the user. The method continues to step 620, where the electronic device maps the calculated distance to a corresponding zoom level. Zoom is determined, for example, as detailed in the description of FIGS. 2A-2B. In some of the described embodiments, the electronic device may associate each zoom level with a corresponding change in distance between the electronic device and the user relative to the initial starting distance.

In accordance with another aspect of the disclosure, in some embodiments, the electronic device may associate each zoom level with the actual corresponding distance between the electronic device and the user, such that the absolute value of that distance is correlated to a particular zoom level. With this alternate embodiment, an AI engine establishes a normal distance for hand positioning of the electronic device while the user is taking a picture or a selfie with the electronic device. That normal distance, which can be determined based on monitoring the usage of the device over multiple image capturing sessions can then be established as the 1X zoom level. With the normalized distance established, the AI engine then establishes additional initial zoom levels corresponding to different distances that are longer and shorter than the baseline distance. These initial zoom levels are recorded and updated as the user continues to use the electronic device and moves the device closer to or further away from the face to zoom in and out on target images. The AI thus performs a rough calibration of the zoom levels based on monitoring the user's movement of the electronic device while in auto zoom mode.

The method continues to step 622, where the device previews on a display of the electronic device a potential image, scaled as per the current zoom level. The method continues to step 624, where the device locks in a zoom level in response to depression of a physical actuator button. The method continues to step 626, where the device captures the preview image at the current zoom level upon receipt of a selection of a virtual image capture selector. The virtual image capture selector is embedded in the user interface of the display of the electronic device as detailed in the description of FIG. 4. The method ends.

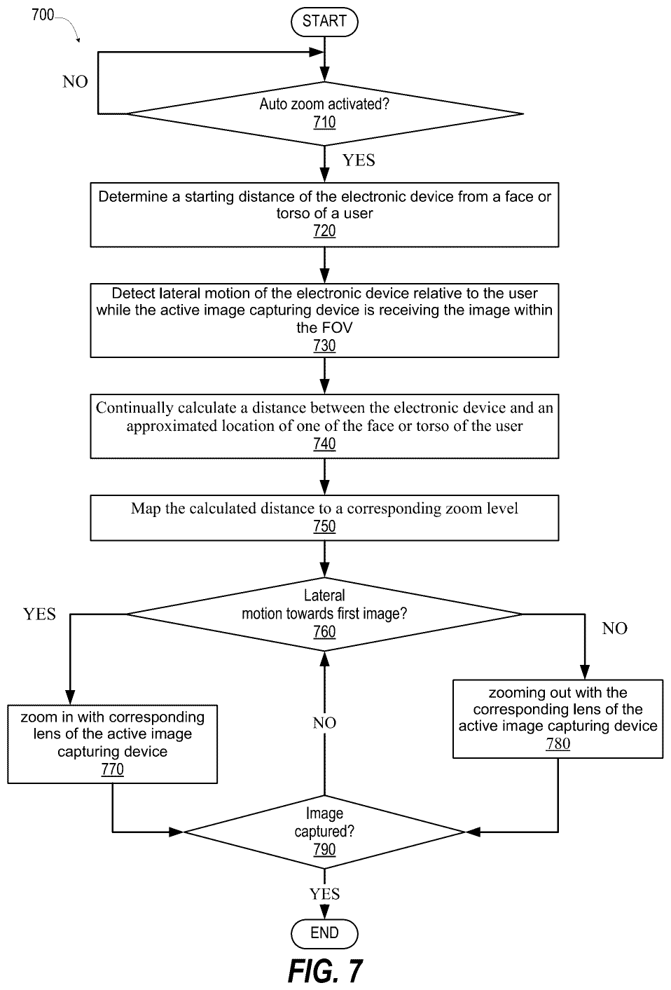

FIG. 7 depicts a flowchart illustrating yet another method for improved zoom functionality for an electronic device having multiple image capturing devices, according to one or more embodiments. The method starts at block 710, where an electronic device comprising a 1st image capturing device and at least one distance measuring unit, and one motion sensor communicatively coupled to a processor determines whether an automated (auto) zoom feature has been activated during image capture by an active image capturing device (ICD) of multiple image capturing devices of the electronic device, the active_image capturing device having a field of view (FOV) that includes an image. If auto zoom has been activated, the method continues to block 720, where the processor determines a starting distance of the electronic device from a face or torso of a user. The method continues at block 730, where the processor determines whether the device detects lateral motion of the electronic device relative to a user while the active image capturing device is receiving the image within the FOV. If the lateral motion of the electronic device relative to the user is detected, the method proceeds to block 740, where the electronic device continually calculates a distance between the electronic device and an approximated location of one of a face or torso of the user. The distance between the electronic device and the user is measured using a distance measuring unit. The method continues to block 750, where the electronic device maps the calculated distance to a corresponding zoom level. Zoom level is determined, for example, as detailed in the description of FIGS. 2A-2B, 3A-3B, and 5A-5B. The electronic device may associate each zoom level with a corresponding distance between the electronic device and the user. The method continues to block 760, where the electronic device determines whether the lateral movement of the electronic device in relation to the user was lateral movement towards a first image (e.g. the object). If the lateral movement of the electronic device was towards the object, the method continues to block 770, where the electronic device zooms in with a corresponding lens of the active image capturing device upon detecting that the electronic device has been moved towards the first image. If the lateral movement of the electronic device was away from the object, the method continues to block 780, where the electronic device zooms out with the corresponding lens of the active image capturing device upon detecting that the electronic device has been moved away from the first image. From both blocks 770 and 780 the method proceeds to block 790, where the device determines whether image capture is triggered. If image capture is triggered, the method includes capturing the image at the current zoom level applied to the active image capturing device. Then method 700 ends. If image capture has not been triggered, the method 700 returns to block 760.

In one or more embodiments, the method includes detecting, by a processor, lateral motion of an electronic device relative to a user. The method includes in response to detecting lateral motion of the electronic device relative to a user while a first image capturing device is activated to receive a first image within a first field of view (FOV) of the first image capturing device, performing at least one of: (i) zooming out with a corresponding first lens of the first image capturing device upon detecting that the electronic device has been moved towards the first image, or (ii) zooming in with the corresponding first lens upon detecting that the electronic device has been moved away from the first image.

In one or more particular embodiment, the method further comprises applying the calculated distance to a corresponding zoom level, and following activation of an auto zoom feature of the electronic device, continually calculating a distance between the electronic device and an approximated location of a face of the user.

In one or more particular embodiments, the method further includes previewing on a display of the electronic device a potential image scaled as per a current zoom level, locking a zoom level in response to depression of a physical actuator button, and capturing the preview image at a current zoom level upon receipt of a selection of a virtual image capture selector.

In one or more embodiments, the method further includes detecting activation of an auto zoom feature of the electronic device, and in response to detecting the activation of the auto zoom feature, outputting a notification of the activation in order to alert a user of the electronic device of availability of the auto zoom feature.

In one or more embodiments, the method further includes presenting a selfie-image of a face of the user within a display screen of the electronic device. The method further includes: zooming in on the face of the user in response to detecting movement of the electronic device towards the face of the user; and zooming out on the face of the user in response to detecting movement of the electronic device away from the face of the user.

In one or more embodiments, the electronic device further comprises a third image capturing device embedded on a same surface as the first image capturing device and having a third lens that has a FOV different from that of the corresponding first lens; and the method further comprises while zooming in and zooming out, autonomously selecting an active image capturing device to capture an image preview from among the first image capturing device and the third image capturing device.

An alternative electronic device configured to implement improved zoom functionality is disclosed. The device includes an enclosure comprising a first surface and a second surface opposed to the first surface. The device includes at least one display device comprising a first display incorporated into the first surface. The enclosure includes at least two image capturing devices including: (i) a first image capturing device embedded in the first surface and having a first lens and that produces first image content; and (ii) a second image capturing device embedded in the second surface and having a second lens that produces second image content. The device includes at least one processor communicatively coupled to the first image capturing device and the second image capturing device, and configured to cause the electronic device to, while one of the first and the second image capturing devices is operating as an active camera in an image capturing mode to capture a first image within a corresponding FOV of the active camera, and the electronic device is positioned such that a next one of the first and the second image capturing devices is facing the user: (i) activate an automated (auto) zoom feature of the electronic device, (ii) determine a first distance between the user and the next one of the first and the second image capturing devices that face the user; and (iii) in response to lateral motion of the electronic device relative to the user, perform, with the active image capturing device, an automated zoom function comprising at least one of: zooming in with a corresponding lens of the active camera upon detecting that the electronic device has been moved away from the user, or zooming out with the corresponding lens of the active camera upon detecting that the electronic device has been moved towards the first user.

In one or more embodiments, the device is further configured such that the first image capturing device is a front image capturing device and the second image capturing device is a rear image capturing device, each having a respective front or rear FOV, and a non-active camera among the first and the second camera detects a location of a face or torso of the user and captures a preview image of the face or toros of the user that is forwarded to an image processing component and utilized by the at least the one processor to calculate relative distance and location of the user from the electronic device.

In one or more embodiments, the device further includes at least one motion sensor which detects rotational and lateral movement of the electronic device, and at least one distance measuring unit that generates data utilized for determining the first distance between the user and the non-active image capturing device. The at least one processor is communicatively coupled to the at least one motion sensor and the at least one distance measuring unit and is further configured to cause the electronic device to, following activation of the auto zoom feature of the electronic device: (i) initiate periodic calculations of changes in a distance between the electronic device and the user, (ii) map a calculated change in the distance to a corresponding zoom level, (iii) apply the zoom level to the first image within the first FOV.

In a particular embodiment, the at least one processor is configured to cause the electronic device to detect a trigger of the auto zoom feature from among: a gesture performed by a user of the device and passage of a preset amount of time during which the user views the first image within a display of the electronic device, and then activate the auto zoom feature in response to detecting the trigger. In a more particular embodiment, the gesture comprises a rotational tilt of the electronic device captured by the at least one motion sensor, while one of the first or second cameras is activated in a picture-taking mode.

In a particular embodiment, the at least one distance measuring unit comprises at least one ultra-wide band (UWB) sensor, and the first distance and subsequent distances between the electronic device and the user are measured using the at least one UWB sensor.

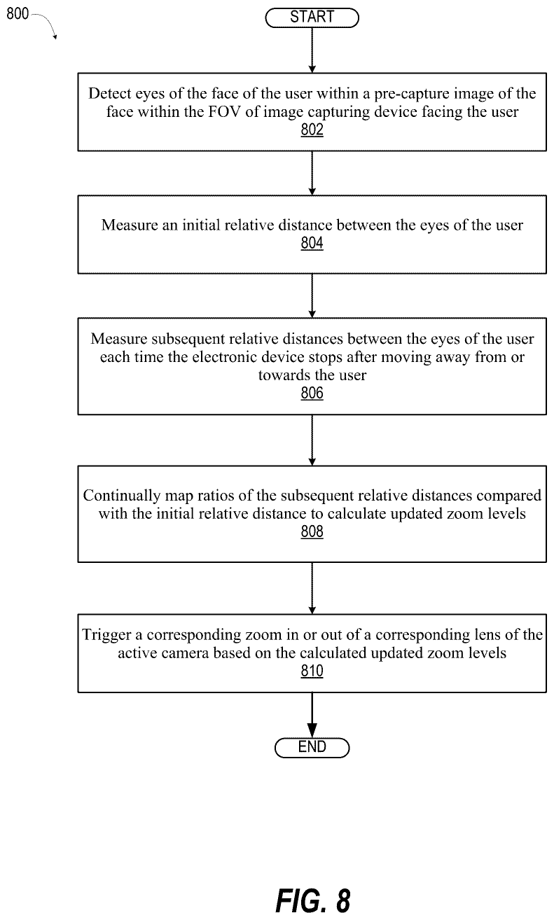

FIG. 8 depicts a flowchart illustrating a method for improved zoom functionality of an electronic device having at least one image capturing device that can be configured to take a selfie image. The method 800 starts at block 802, where an electronic device detects the eyes of the face of a user within a pre-capture image of the face within the FOV of an active camera facing the user during a selfie mode while auto zoom feature is activated. The method 800 continues to block 804, where the electronic device measures an initial relative distance between the eyes of the user within the preview image. The distance between the eyes can be measured in pixels shown on a preview image on a display of the electronic device. The initial relative distance is stored as a baseline distance that correlates to 1× zoom. The device may contemporaneously activate the auto zoom feature. The method 800 continues to block 806, where the electronic device measures subsequent relative distances between the eyes of the user each time the electronic device stops after moving away from the user or towards the user. In some embodiments, the processor makes use of an accelerometer or similar device of the electronic device that senses lateral movement of the device relative to the user's face. The method 800 continues to block 808, where the electronic device continually determines/calculates the change in relative distance between the eyes from the initial relative distance and maps/correlates the subsequent changes in distances between the eyes of the user to updated zoom levels. In some embodiments, the electronic device accesses a pre-established zoom table (e.g., table 350) to determine the zoom level to apply to the active image capturing device. The method continues to block 810, where the electronic device triggers a corresponding zoom in or out of the lens of the active camera based on the calculated updated zoom levels. Then method 800 ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed herein, but that the innovation will include at least all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or to limit the innovation to the features and concepts explicitly disclosed. Many modifications and variations will be apparent to those of ordinary skill in the art without departing from the scope and spirit of the innovation. The embodiments were chosen and described in order to best explain the principles of the innovation and the practical application thereof, and to enable others of ordinary skill in the art to understand the innovation for various embodiments with various modifications as are suited to the particular use contemplated.

What is claimed is:

1. An electronic device comprising:
an enclosure comprising a first surface and a second surface opposed to the first surface;
at least one display device comprising a first display incorporated into the first surface;
at least one image capturing devices including: (i) a first image capturing device embedded in the first surface and having a first lens and that produces first image content; and (ii) a second image capturing device embedded in the second surface and having a second lens that produces second image content;
at least one distance measuring unit; and
at least one processor communicatively coupled to the at least one display device, the first image capturing device, the second image capturing device, and the at least one distance measuring unit, and configured to cause the electronic device to:
activate an automated (auto) zoom feature of the electronic device while one of the first and second image capturing devices is selected as an active camera to receive and capture a first image within a corresponding field of view (FOV) of the selected image capturing device;
determine a starting distance from the electronic device to a face or torso of a user;
in response to detecting lateral motion of the electronic device relative to the user while the auto zoom feature is activated with the selected image capturing device, perform, with the selected image capturing device, an automated zoom by the active image capturing device comprising at least one of:
zoom in with a corresponding lens of the active image capturing device upon detecting that the electronic device has been moved towards the first image; or
zoom out with the corresponding lens upon detecting that the electronic device has been moved away from the first image.

2. The electronic device of claim 1, wherein:
the first surface is opposed to the second surface and is directed towards a face of the user; and the at least one processor is further configured to:
following activation of an auto zoom feature of the electronic device, continually calculate a distance between the electronic device and an approximated location of one of the face or torso of the user;
map a calculated distance to a corresponding zoom level; and
apply the corresponding zoom level to a lens of the active image capturing device to provide a modified image of the FOV that is one of zoomed in or zoomed out by the corresponding zoom level.

3. The electronic device of claim 1, further comprising an ultrawide band (UWB) sensor communicatively coupled to the processor, wherein the processor is configured to cause the electronic device to:
determine the distance between the electronic device and an approximated location of the face or torso of the user via detection of at least one UWB signal from a wearable UWB tag of the user.

4. The electronic device of claim 1, wherein the at least one processor is further configured to:
detect eyes of the face of the user within a pre-capture image of the face within the FOV of an image capturing device facing the user;
measure an initial relative distance between the eyes of the user contemporaneously with activating the auto zoom feature;
measure subsequent relative distances between the eyes of the user each time the electronic device stops after moving away from or towards the user;
continually map ratios of the subsequent relative distances compared with the initial relative distance to calculate updated zoom levels; and
trigger a corresponding zoom in or out of a corresponding lens of the active camera based on the calculated updated zoom levels.

5. The electronic device of claim 1, wherein the at least one processor is further configured to:
preview on a display of the electronic device a potential image scaled as per a current zoom level;
lock a zoom level in response to one of detecting a user input to lock a zoom or non-linear movement of the device for more than a preset threshold period of time following a zoom adjustment; and
capture the preview image at a current zoom level upon receipt of a selection of one of a virtual image capture selector on the display or a physical actuator button.

6. The electronic device of claim 1, further comprising at least one motion sensor communicatively coupled to the processor, wherein the processor is configured to cause the electronic device to:
activate the auto zoom feature of the selected image capturing device in response to in response to detecting a gesture comprising a rotational tilt of the electronic device by the user while the selected image capturing device is in an image capturing mode.

7. The electronic device of claim 1, wherein auto zoom feature is automatically activated in response to passage of a preset time of a focused image preview appearing on a display of the electronic device without movement of the electronic device while in a picture taking mode.

8. The electronic device of claim 1, wherein the at least one processor is further configured to:
detect activation of the auto zoom feature of the electronic device; and
in response to detecting the activation of the auto zoom feature, output a notification of the activation in order to alert a user of the electronic device of an availability of auto zoom feature.

9. The electronic device of claim 1, wherein the at least one processor is further configured to:
in response to the electronic device being placed in a selfie mode, present a selfie-image of a face of the user within a display screen of the electronic device; and
apply a distance-based auto zoom feature to determine a level of zoom to apply to the active camera capturing the selfie, by zooming in on the face of the user in response to detecting movement of the electronic device towards the face of the user and zooming out on the face of the user in response to detecting movement of the electronic device away from the face of the user.

10. The electronic device of claim 1, further comprising:
a third image capturing device embedded on a same surface as the first image capturing device and having a third lens that has a different FOV from the first lens; and
wherein to zoom in and zoom out, the at least one processor autonomously selects an active image capturing device to capture an image preview from among the first image capturing device and the third image capturing device.

11. A method comprising:
activating an automated (auto) zoom feature of an electronic device during image capture by an active image capturing device (ICD) of multiple image capturing devices of the electronic device, the active_image capturing device having a field of view (FOV) that includes an image;
determine a starting distance of the electronic device from a face or torso of a user; and
in response to detecting lateral motion of the electronic device relative to the user while the active image capturing device is receiving the image within the FOV, performing an automated zoom by the active image capturing device comprising at least one of:
zooming in with a corresponding lens of the active image capturing device upon detecting that the electronic device has been moved towards a first image; or
zooming out with the corresponding lens of the active image capturing device upon detecting that the electronic device has been moved away from the first image.

12. The method of claim 11, further comprising:
following activation of an auto zoom feature of the electronic device, continually calculating a distance between the electronic device and an approximated location of one of the face or torso of the user;
mapping the calculated distance to a corresponding zoom level; and
applying the corresponding zoom level to a lens of the active image capturing device to provide a modified image of the FOV that is one of zoomed in or zoomed out by the corresponding zoom level.

13. The method of claim 11, further comprising:
detecting eyes of a face of the user within a pre-capture image of the face within a FOV of an image capturing device facing the user;
measuring an initial relative distance between the eyes of the user contemporaneously with activating the auto zoom feature;
measuring subsequent relative distances between the eyes of the user each time the electronic device stops after moving away from or towards the user;
continually mapping ratios of the subsequent relative distances compared with the initial relative distance to calculate updated zoom levels; and
triggering a corresponding zoom in or out of a corresponding lens of the active image capturing device based on the calculated updated zoom levels.

14. The method of claim 11, further comprising:
detecting activation of the auto zoom feature of the electronic device,
wherein the activation is triggered by one of (i) detecting a motion of the electronic device pre-established as trigger, and (ii) detecting a passage of more than a preset threshold amount of time with the active image capturing device focused on an image without movement of the electronic device; and
in response to detecting the activation of the auto zoom feature, outputting a notification of the activation in order to alert a user of the electronic device of an availability of the auto zoom feature.

15. The method of claim 14, further comprising:
previewing on a display of the electronic device a potential image scaled as per a current zoom level;
locking a zoom level in response to depression of a physical actuator button; and
capturing the preview image at a current zoom level upon receipt of a selection of a virtual image capture selector.

16. The method of claim 11, further comprising:
in response to the electronic device being placed in a selfie mode, presenting a selfie-image of a face of the user within a display screen of the electronic device; and
applying a distance-based auto zoom feature to determine a level of zoom to apply to the active image capturing device capturing the selfie, by zooming in on the face of the user in response to detecting movement of the electronic device towards the face of the user and zooming out on the face of the user in response to detecting movement of the electronic device away from the face of the user.

17. The method of claim 11, wherein:
the electronic device further comprises a third image capturing device embedded on a same surface as the active image capturing device and having a second FOV of the image different from that of the corresponding first lens of the active image capturing device; and
the method further comprises autonomously selecting an active image capturing device to capture an image preview from among the active image capturing device and the third image capturing device based on an amount of zooming in and zooming out required as the electronic device is moved towards and away from the face or torso of the user.

18. A computer program product comprising a non-transitory computer readable medium having program instructions that when executed by a processor of an electronic device, configure the electronic device to perform functions comprising:
activating an automated (auto) zoom feature of the electronic device, while one of a first image capturing device and second image capturing device is selected as an active image capturing device to receive and capture a first image within a corresponding field of view (FOV) of the selected active image capturing device;
determining a starting distance from the electronic device to a face or torso of a user; and
in response to detecting lateral motion of the electronic device relative to the user while the auto zoom feature is activated with the selected active image capturing, perform, with the selected active image capturing device, an automated zoom by the active image capturing device comprising at least one of:
zooming out with a corresponding lens upon detecting that the electronic device has been moved towards the first image; or
zooming in with the corresponding lens upon detecting that the electronic device has been moved away from the first image.

19. The computer program product of claim 18, the program instructions further comprising program instructions that when executed by the processor of the electronic device, configure the electronic device to perform functions comprising:
following activation of an auto zoom feature of the electronic device, continually calculating a distance between the electronic device and an approximated location of one of the face or torso of the user;
mapping a calculated distance to a corresponding zoom level; and
applying the corresponding zoom level to a lens of the active image capturing device to provide a modified image of the FOV that is one of zoomed in or zoomed out by the corresponding zoom level.

20. The computer program product of claim 18, the program instructions further comprising program instructions that when executed by the processor of the electronic device, configure the electronic device to perform functions comprising:
detecting eyes of the face of the user within a pre-capture image of the face within a FOV of an image capturing device facing the user;
measuring an initial distance between the eyes of the user contemporaneously with activating the auto zoom feature;
measuring subsequent distances between the eyes of the user each time the electronic device stops after moving away from or towards the user;
continually mapping ratios of the subsequent distances compared with an initial relative distance to calculate updated zoom levels; and
triggering a corresponding zoom in or out of a corresponding lens of the active image capturing device based on the calculated updated zoom levels.
